(19) United States
(12) Patent Application Publication
(10) Pub. No.: US 2003/0155721 A1
(43) Pub. Date: Aug. 21, 2003

(54) Metal-to-metal seal and method of making same

(76) Inventor: Qiu Shi Zheng, Spring, TX (US)

Correspondence Address: Daren C. Davis, Patent Agent, Williams, Morgan & Amerson, P.C., Suite 1100, 10333 Richmond Ave., Houston, TX, 77042, US

(21) Appl. No.: 10/348,257

(22) Filed: Jan. 21, 2003

Related U.S. Application Data
(60) Provisional application No. 60/357,407, filed on Feb. 15, 2002.

(51) Int. Cl. F16L 5/02

(52) U.S. Cl. 277/607

(57) ABSTRACT

A seal for sealing against a surface includes a body having a deflectable intermediate portion terminating in an end portion and a sealing element including a softer material than that of the surface and disposed along the end portion of the body. A method of producing a seal includes providing a body comprising a deflectable intermediate portion terminating in an end portion and disposing a sealing element including a softer material than that of the body along the end portion of the body. A seal includes a body including a deflectable intermediate portion terminating in an end portion, a sealing element including a softer material than that of the body and disposed along the end portion of the body, and means for retaining the sealing element at the end portion.

### CROSS REFERENCE TO RELATED APPLICATIONS

This application claims the benefit of U.S. provisional application No. 60/357,407, filed Feb. 15, 2002.

### BACKGROUND OF THE INVENTION

1. Field of the Invention

This invention relates to metal-to-metal seals and, in particular, to a metal-to-metal seal having a softer metallic seal contact portion.

2. Description of the Related Art

Many types of equipment, particularly equipment used in the oil and gas industry, includes fluid seals that operate in extremely hostile environments. For example, flow control equipment associated with oil and gas wells, such as Christmas trees, valves, connectors, and the like, include numerous seals that isolate the produced fluids from the environment. These seals may also isolate control fluids, such as hydraulic fluid or methanol, from the environment. In many wells, the produced fluid exits the well at very high pressures and temperatures. Conventional non-metallic (e.g., elastomeric) seals that are often used in such flow control equipment may be incapable of withstanding the high temperatures and pressures of the produced fluids. As a result, the seals may extrude and mechanically degrade, which may result in seal failure. In oil and gas wells, there is also a risk of fire, which may damage or destroy such elastomeric seals.

One solution to these problems is to replace the elastomeric seals with metal-to-metal seals in areas of the equipment that encounter high pressure and/or high temperature conductions. One particular type of metal-to-metal seal is known as a straight bore metal seal, which comprises a mechanically energized sealing profile that seals against a generally smooth, cylindrical surface. However, the sealing area is generally small, and these seals are typically not reusable. Further, high strength nickel alloys, which are generally expensive, are often selected for use in these seals due to corrosion requirements. Seals of this type may also be sensitive to the surface finish of the sealing profile and the surface on which the sealing profile contacts. Such alloys may be hard relative to the material of the surface on which the sealing profile contacts. Thus, damage to sealing surfaces may result during installation. Such seals may also be subject to galling during use.

The present invention is directed to overcoming, or at least reducing, the effects of one or more of the problems set forth above.

### SUMMARY OF THE INVENTION

In one aspect of the present invention, a seal for sealing against a surface is provided. The seal includes a body comprising a deflectable intermediate portion terminating in an end portion and a sealing element comprising a softer material than that of the surface and disposed along the end portion of the body.

In another aspect of the present invention, a method of producing a seal is provided. The method includes providing a body comprising a deflectable intermediate portion terminating in an end portion and disposing a sealing element comprising a softer material than that of the body along the end portion of the body.

In yet another aspect of the present invention, a seal is provided. The seal includes a body comprising a deflectable intermediate portion terminating in an end portion, a sealing element comprising a softer material than that of the body and disposed along the end portion of the body, and means for retaining the sealing element at the end portion.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a cross-sectional view of a first illustrative embodiment of the present invention being used to seal between two flanges;

FIG. 2 is a cross-sectional view of a second illustrative embodiment of the present invention;

FIG. 3 is a cross-sectional view of a third illustrative embodiment of the present invention;

FIG. 4 is a cross-sectional view of a fourth illustrative embodiment of the present invention;

FIG. 5 is a cross-sectional view of a fifth illustrative embodiment of the present invention;

FIGS. 6A-6G are cross-sectional views of a sixth illustrative embodiment of the present invention;

FIG. 7 is a cross-sectional view of a seventh illustrative embodiment of the present invention;

FIG. 8 is a cross-sectional view of an eighth illustrative embodiment of the present invention;

FIG. 9A is a cross-sectional view of a ninth illustrative embodiment of the present invention;

FIG. 9B is an enlarged cross-sectional view of a portion of the embodiment of FIG. 9A; and

FIG. 10 is a cross-sectional view of a tenth illustrative embodiment of the present invention;

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention is directed to a generally annular metal-to-metal seal, such as a straight bore metal seal, a rough casing metal seal, an externally energized an FX seal, an AX seal, or the like, having a high strength metallic seal body and a softer metallic sealing portion for sealing against a generally annular surface. The seal body incorporates a spring-like characteristic such that, when installed, it is capable of urging the sealing portion into contact with the annular surface. The sealing portion, by virtue of its softer material characteristics, is capable of conforming to the annular surface, even when the annular surface has an irregular geometry and/or has a less-than-desirable surface finish. Thus, the seal is capable of inhibiting high pressure and/or high temperature fluid from flowing between the sealing portion and the annular surface on which it is seated, even when the annular surface has a less-than-optimum configuration. Further, if galling or other damage occurs during installation and operation, damage will generally be confined to the seal, which can more readily and cost effectively replaced, as compared to repairing the annular surface on which it seals.

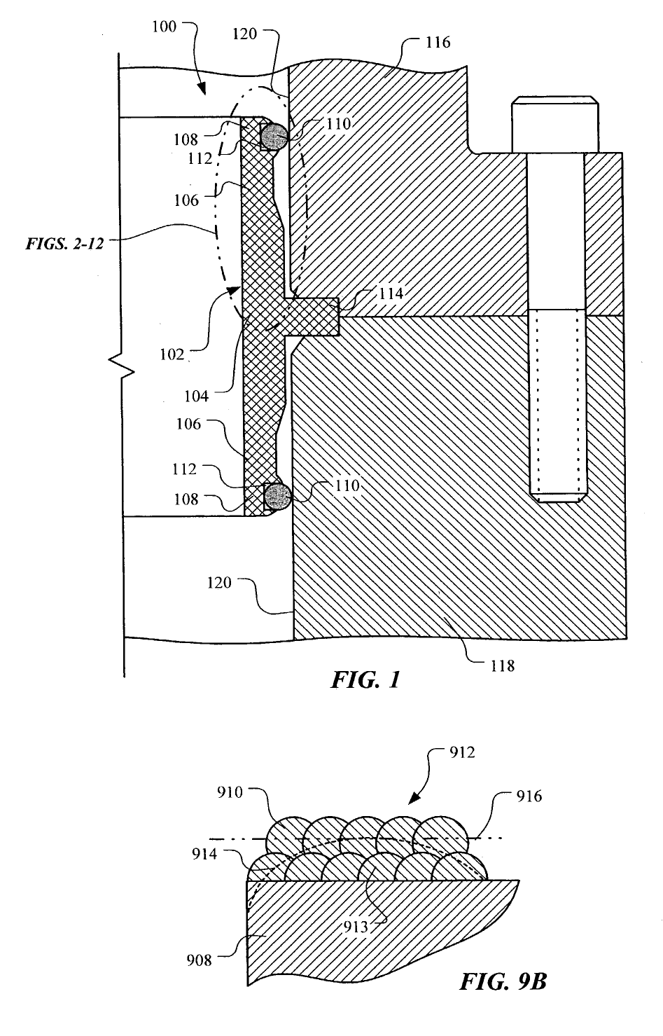

FIG. 1 depicts a first illustrative embodiment of a metal-to-metal seal according to the present invention. In the illustrated embodiment, a metal-to-metal seal 100 comprises a generally annular metal seal body 102 having a base portion 104 and one or more flexible intermediate portions 106, each terminating in end portions 108. A sealing portion 110, comprising a softer material than that of a surface on which it seals, is disposed in and retained by a groove 112 defined by each of the end portions 108. The seal body 102 further comprises a web portion 114 capable of being retained between flanges 116, 118. The flexible intermediate portions 106 provide the body 102 with a spring-like characteristic, such that the intermediate portions 106 become flexed and, thus, preloaded during assembly. Accordingly, when installed, the intermediate portions 106 urge the sealing insert 112 against a surface 120 to maintain interference sealing therewith. In various embodiments, the surface 120 may generally form a right cylinder, as shown in FIG. 1, or may be tapered (i.e., conical or frustoconical) and may have a relatively rough surface finish, such as, for example, 125 micro-inches RMS, without jeopardizing the fluid tightness of the seal. Thus, when installed, the seal 100 inhibits a flow of fluid between the sealing portions 110 and the surface 120.

In certain embodiments, the material comprising the sealing portions 110 may be significantly softer and have a significantly lower yield strength than that of the surface 120. For example, the material of the sealing portions 110 may have a yield strength that is about ⅕th to about ⅓rd the yield strength of the seal body 102. Thus, the likelihood of damage to the surface 120 during installation is reduced, since the sealing portions 110 may readily deform against the surface 120. Further, galling may be reduced over conventional metal-to-metal seals.

While FIG. 1 illustrates a particular configuration of the seal 100, the present invention is not so limited. Rather, the various seal portion embodiments disclosed herein (e.g., the seal portions 110) may be used in any chosen configuration of metal-to-metal seal, such as those shown and described in commonly owned U.S. Pat. No. 4,471,965 to Jennings et al., the entirety of which is hereby incorporated by reference for all purposes, and in commonly owned U.S. patent application Ser. No. 09/819,121 to Janoff et al., filed on Mar. 27, 2001, the entirety of which is incorporated by reference for all purposes.

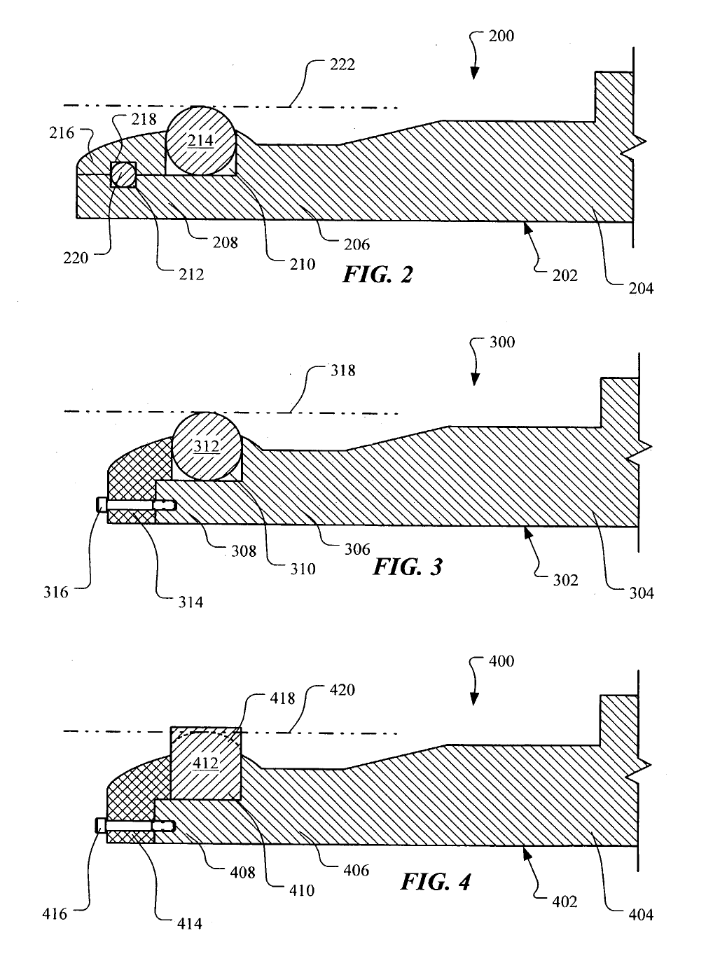

FIGS. 2-10 depict various alternative embodiments of metal-to-metal seals according to the present invention. In each figure, a portion of seal embodiment is shown generally corresponding to the portion indicated in FIG. 1. As previously indicated, however, aspects of the embodiments discussed and shown herein may be applied to any chosen metal-to-metal seal type. For example, the sealing portions discussed and shown herein may seal against an internal diameter or an external diameter, and the seal configuration may be so modified.

FIG. 2 shows a second illustrative embodiment of a metal-to-metal seal according to the present invention. In the illustrated embodiment, a metal-to-metal seal 200 comprises a generally annular metal seal body 202 having a base portion 204 and one or more flexible intermediate portions 206, each terminating in end portions 208. The end portion 208 defines a recess 210 and a groove 212 therein. The seal 200 further includes a generally annular wire-type sealing portion 214 comprising a material softer than that of the base portion 204. The sealing portion 214 is disposed on the recess 210 and is captured thereon by a retainer 216. The retaining element 216 defines a groove 218 therein, generally corresponding to and aligned with the groove 212. The retaining element 216 is secured to the end portion 208 via a wire ring 220, which is disposed within the void formed by the generally aligned grooves 212, 218. Thus, the seal 200 is capable of inhibiting a flow of fluid between the sealing portion 214 and a surface 222 (shown in phantom) in contact therewith.

FIG. 3 shows a third illustrative embodiment of a metal-to-metal seal according to the present invention. In the illustrated embodiment, a metal-to-metal seal 300 comprises a generally annular metal seal body 302 having a base portion 304 and one or more flexible intermediate portions 306, each terminating in end portions 308. The end portion 308 defines a recess 310 on which a generally annular wire-type sealing element 312 is disposed. The sealing element 312 comprises a softer material than that of the seal body 302. The sealing element 312 is captured on the recess 310 by a retainer 314. In one embodiment, the retainer 314 is secured to the end portion 308 by one or more fasteners 316, such as, for example, one or more screws. The scope of the present invention, however encompasses any chosen type of fastener for securing the retainer 314 to the end portion 308. Thus, the seal 300 is capable of inhibiting a flow of fluid between the sealing portion 312 and a surface 318 (shown in phantom).

FIG. 4 depicts a fourth illustrative embodiment of a metal-to-metal seal according to the present invention. In the illustrated embodiment, a metal-to-metal seal 400 comprises a generally annular metal seal body 402 having a base portion 404 and one or more flexible intermediate portions 406, each terminating in end portions 408. The end portion 408 defines a recess 410 on which a generally annular sealing element blank 412 is disposed. The sealing element 412 comprises a softer material than that of the seal body 402. The sealing element blank 412 is captured on the recess 410 by a retainer 414. In one embodiment, the retainer 414 is secured to the end portion 408 by one or more fasteners 416, such as, for example, one or more screws. The scope of the present invention, however encompasses any chosen type of fastener for securing the retainer 414 to the end portion 408. After the sealing element blank 412 has been installed on the recess 410 and the retainer 414 has. been secured to the end portion 408, the sealing element blank 412 is machined to form a sealing profile 418. Thus, the seal 400 is capable of inhibiting a flow of fluid between sealing profile 418 of the machined sealing portion blank 412 and a surface 420 (shown in phantom).

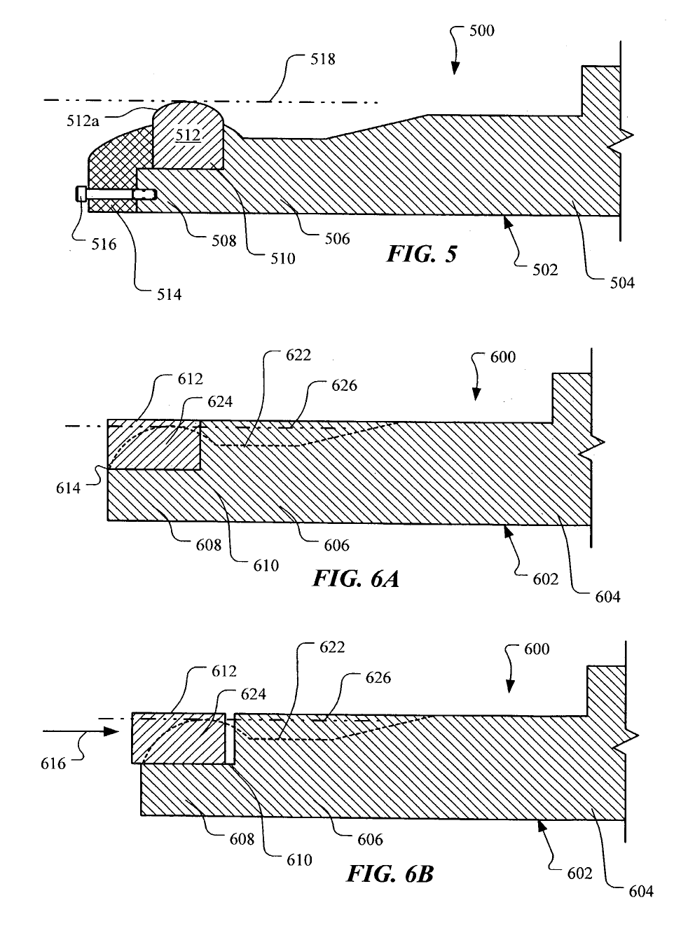

FIG. 5 depicts a fifth illustrative embodiment of a metal-to-metal seal according to the present invention. In the illustrated embodiment, a metal-to-metal seal 500 comprises a generally annular metal seal body 502 having a base portion 504 and one or more flexible intermediate portions 506, each terminating in end portions 508. The end portion 508 defines a recess 510 on which a generally annular sealing element 512 is disposed. The sealing element 512 comprises a softer material than that of the seal body 502 and comprises a pre-machined sealing profile 512a. The sealing element 512 is captured on the recess 510 by a retainer 514. In one embodiment, the retainer 514 is secured to the end portion 508 by one or more fasteners 516, such as, for example, one or more screws. The scope of the present invention, however encompasses any chosen type of fastener for securing the retainer 514 to the end portion 508. Thus, the seal 500 is capable of inhibiting a flow of fluid between the sealing profile 512a l of the sealing element 512 and a surface 518 (shown in phantom).

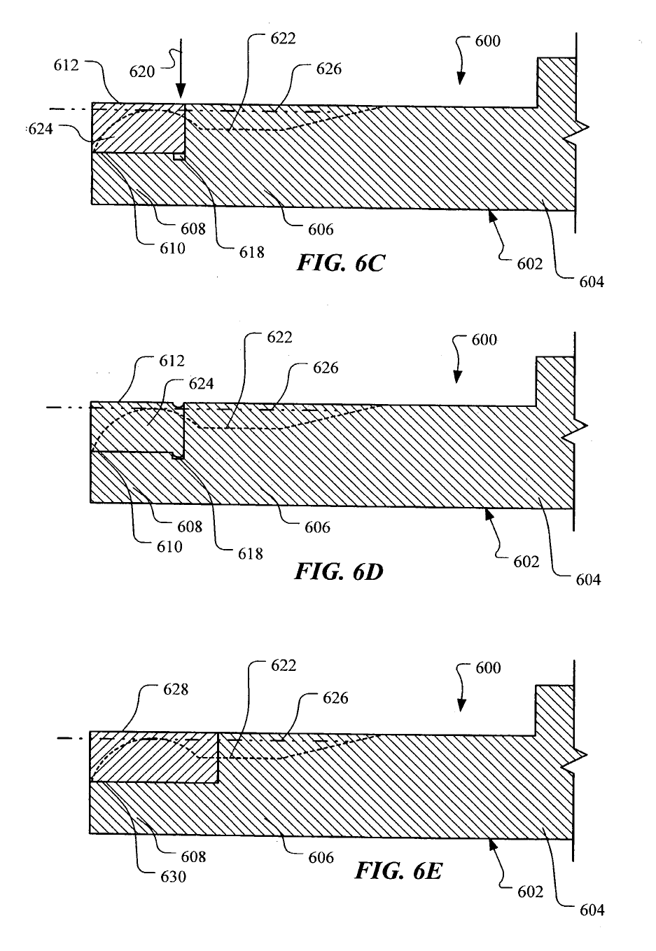

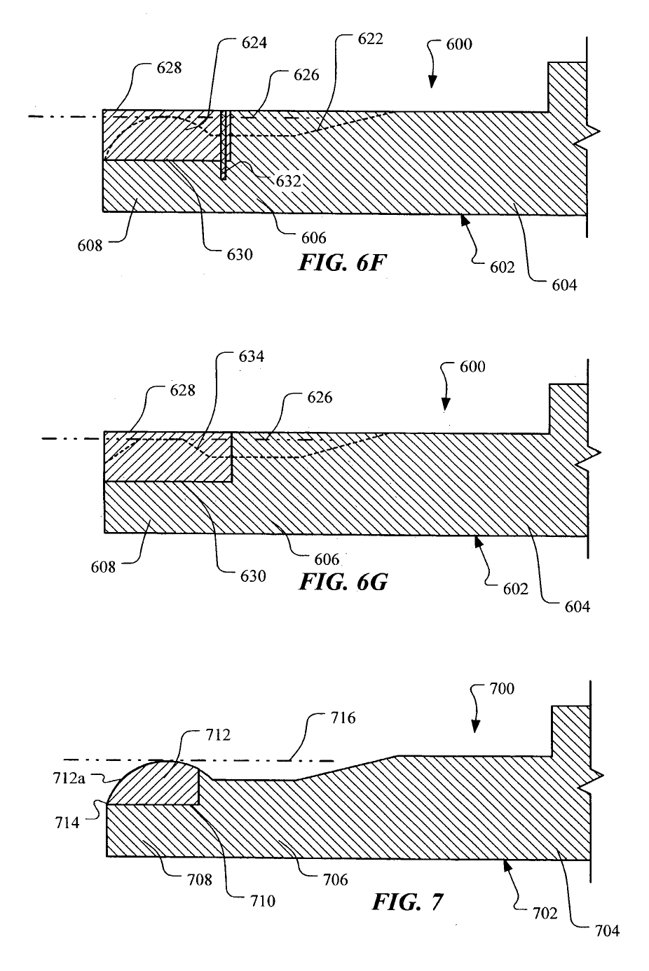

FIGS. 6A-6G depict a sixth illustrative embodiment of a metal-to-metal seal according to the present invention. In the illustrated embodiment, a metal-to-metal seal 600 comprises a generally annular metal seal body 602 having a seal body blank 604 defining a recess 610 on which a generally annular sealing element blank 612 is disposed. The sealing element blank 612 may be captured on the recess 610 by any chosen means. For example, the sealing element blank 612 and the seal body blank 604 may be edge punched, tack welded, glued, or soldered generally at 614, as shown in FIG. 6A. The sealing element blank 612 may be secured to the recess 610 by pressing the sealing element blank 612 onto the end portion 608 (as indicated by an arrow 616) such that a press or interference fit exists between the sealing element blank 612 and the recess 610, as shown in FIG. 6B.

Alternatively, as shown in FIGS. 6C and 6D, the seal body blank 602 may further define an undercut 618. In such an embodiment, the sealing element blank 612 may be retained on the recess 610 by punching, pressing, swaging, indenting, or otherwise applying a force to the sealing element blank 612 (as indicated by an arrow 620) such that a portion of the sealing element blank 612 is plastically deformed into the undercut 618.

As shown in FIG. 6E, the seal 600 may alternatively comprise a larger sealing element blank 628 that extends beyond the end portion 608 and into the intermediate portion 606 on a recess 630. The sealing element blank 628 may be secured to the recess 630, for example, by any of the means described above in reference to FIGS. 6A-6D. As shown in FIG. 6F, the sealing element blanks 612, 628 may be secured to the recesses 610, 630 by one or more fasteners 632, such as, for example, one or more rivets.

Irrespective of the manner in which the sealing element blanks 612, 628 are secured to the seal body blank 602, the seal body blank 602 and the sealing element blanks 612, 628 are subsequently machined generally along a profile 622 to form at least one of a base portion 604, one or more flexible intermediate portions 606, end portions 608, and a sealing element 624. Thus, the seal 600 is capable of inhibiting a flow of fluid between the sealing element 624 and a surface 626 (shown in phantom).

While the various embodiments discussed above and illustrated in the figures have sealing profiles that are generally curved or round, the present invention is not so limited. Rather, the present invention encompasses any chosen shape of sealing profile. For example, as shown in FIG. 6G, the sealing element blank 628 is machined to a profile 634 having generally a trapezoidal cross-sectional shape.

FIG. 7 depicts a seventh illustrative embodiment of a metal-to-metal seal according to the present invention. In the illustrated embodiment, a metal-to-metal seal 700 comprises a generally annular metal seal body 702 having a base portion 704 and one or more flexible intermediate portions 706, each terminating in end portions 708. The end portion 708 defines a recess 710 on which a generally annular sealing element 712 is disposed. The sealing element 712 comprises a softer material than that of the seal body 702 and comprises a pre-machined sealing profile 712a. In the illustrated embodiment, the sealing element 712 may be captured on the recess 710 by edge punching, tack welding, gluing, or soldering the sealing element 712 to the end portion 708 generally at 714. Thus, the seal 700 is capable of inhibiting a flow of fluid between the sealing profile 712a of the sealing element 712 and a surface 716 (shown in phantom).

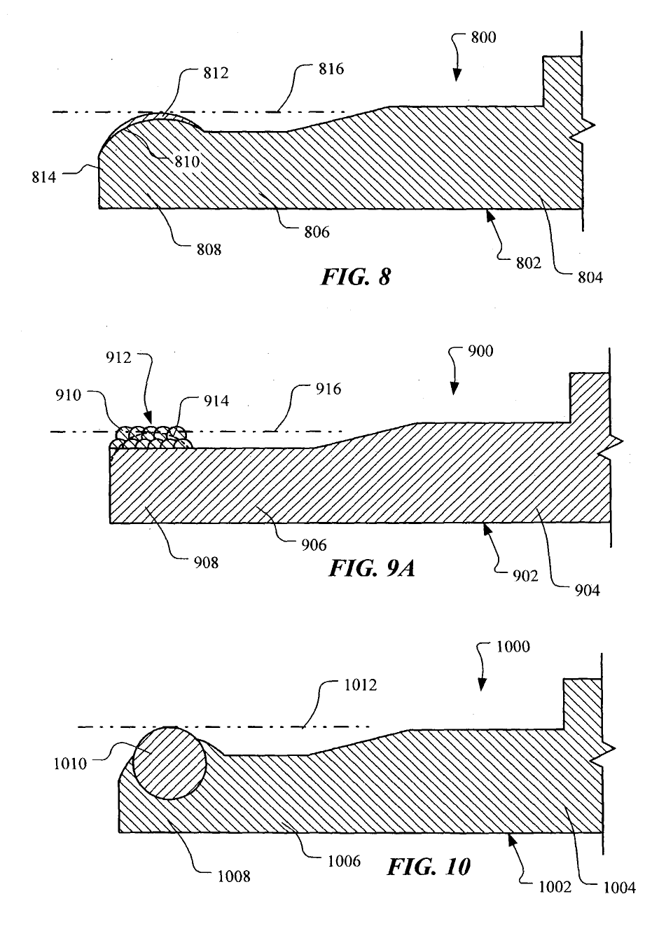

FIG. 8 depicts an eighth illustrative embodiment of a metal-to-metal seal according to the present invention. In the illustrated embodiment, a metal-to-metal seal 800 comprises a generally annular metal seal body 802 having a base portion 804 and one or more flexible intermediate portions 806, each terminating in end portions 808. The end portion 808 defines a sealing subprofile 810. A sealing element 812 comprises a layer of material softer than that of the seal body 802 is brush plated or otherwise applied to the sealing subprofile 810 to form a sealing profile 814. Thus, the seal 800 is capable of inhibiting a flow of fluid between the sealing profile 814 and a surface 816 (shown in phantom).

FIGS. 9A and 9B depict a ninth illustrative embodiment of a metal-to-metal seal according to the present invention. In the illustrated embodiment, a metal-to-metal seal 900 comprises a generally annular metal seal body 902 having a base portion 904 and one or more flexible intermediate portions 906, each terminating in end portions 908. One or more beads 910 of material that is softer than that of the base portion 904 are welded, brazed, or otherwise applied onto the end portion 908 to form an overlay 912. The overlay 912 is subsequently machined to form a sealing element 913 having a sealing profile 914. Thus, the seal 900 is capable of inhibiting a flow of fluid between the sealing profile 914 and a surface 916 (shown in phantom).

FIG. 10 depicts a tenth illustrative embodiment of a metal-to-metal seal according to the present invention. In the illustrated embodiment, a metal-to-metal seal 1000 comprises a generally annular metal seal body 1002 having a base portion 1004 and one or more flexible intermediate portions 1006, each terminating in end portions 1008. The seal 1000 further comprises one or more generally annular wire-type sealing elements 1010 disposed in each of the end portions 1008. One method by which the seal 1000 may be produced is to cast the seal body 1002 around the one or more sealing elements 1010. Thus, the seal 1000 is capable of inhibiting a flow of fluid between the sealing elements 1010 and a surface 1012 (shown in phantom).

In each of the embodiments discussed and shown herein, the seal bodies 102, 202, 302, 402, 502, 702, 802, 902, 1002 and the seal body blank 602 may comprise a metallic material having a yield strength within a range of about 500 MPa to about 1000 MPa, such as some nickel-chromium alloys (e.g., Inconel® 718 and Inconel® 625) and some alloy steels (e.g., type 4130 and type 4140 steels). The sealing elements 110, 214, 312, 412, 512, 624, 712, 812, 913, 1010 may comprise a metallic material having a yield strength within a range of about 200 MPa to about 550 MPa, which are softer than that of the seal bodies 102, 202, 302, 402, 502, 702, 802, 902, 1002 and the seal body blank 602, such as some nickel-chromium alloys (e.g., Incoloy® 825) and type 316 stainless steel.

In other embodiments, the seal bodies 102, 202, 302, 402, 502, 702, 802, 902, 1002 and the seal body blank 602 may comprise a metallic material having a hardness within a range of about 22 Rc to about 40 Rc. Further, the sealing elements 110, 214, 312, 412, 512, 624, 712, 812, 913, 1010 may comprise a metallic material having a hardness within a range of about 60 Rb to about 90 Rb.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A seal for sealing against a surface, comprising:
a body comprising a deflectable intermediate portion terminating in an end portion; and
a sealing element comprising a softer material than that of the surface and disposed along the end portion of the body.

2. A seal, according to claim 1, wherein the end portion defines a groove therein and the sealing element comprises a wire-type element retained within the groove.

3. A seal, according to claim 1, wherein the end portion defines a recess in which the sealing element is disposed and the seat further comprises a retainer, secured to the end portion, for retaining the sealing element on the recess.

4. A seal, according to claim 3, wherein:
the end portion further defines a first groove;
the retainer further defines a second groove generally aligned with the first groove; and
the seal further comprises a wire ring, disposed within the generally aligned first and second grooves, for securing the retainer to the end portion.

5. A seal, according to claim 3, wherein the retainer is secured to the end portion by at least one fastener.

6. A seal, according to claim 3, wherein the sealing element comprises a wire-type element.

7. A seal, according to claim 3, wherein the sealing element comprises a sealing element blank that is machined after assembly of the seal.

8. A seal, according to claim 3, wherein the sealing element comprises a previously machined sealing element.

9. A seal, according to claim 1, wherein the body defines a recess proximate the end portion and the sealing element is retained on the recess.

10. A seal, according to claim 9, wherein the sealing element is retained on the recess by a press fit or an interference fit.

11. A seal, according to claim 9, wherein the sealing element is retained on the recess by at least one of an edge punch, a tack weld, glue, and solder.

12. A seal, according to claim 9, wherein the end portion defines an undercut and the sealing element is retained on the recess by an upset portion of the sealing element extending into the undercut.

13. A seal, according to claim 9, wherein the sealing element is retained on the recess by at least one fastener extending into the sealing element and into the end portion.

14. A seal, according to claim 9, wherein the sealing element comprises a sealing element blank that is machined after assembly of the seal.

15. A seal, according to claim 9, wherein the sealing element comprises a previously machined sealing element.

16. A seal, according to claim 9, wherein the recess is defined by the end portion.

17. A seal, according to claim 9, wherein the recess is defined by the end portion and the intermediate portion.

18. A seal, according to claim 1, wherein the sealing element comprises a curvilinear sealing profile in cross-section.

19. A seal, according to claim 1, wherein the sealing element comprises a generally straight sealing profile in cross-section.

20. A seal, according to claim 1, wherein the body comprises a material selected from the group consisting of nickel-chromium alloys, Inconel® 718, Inconel® 625, alloy steels, type 4130 steel and type 4140 steel.

21. A seal, according to claim 1, wherein the body comprises a material having a tensile strength within a range of about 500 MPa to about 1000 MPa.

22. A seal, according to claim 1, wherein the body comprises a material having a hardness within a range of about 22 Rc to about 40 Rc.

23. A seal, according to claim 1, wherein the sealing element comprises a material selected from the group consisting of nickel-chromium alloys, Incoloy® 825, stainless steels, and type 316 stainless steel.

24. A seal, according to claim 1, wherein the sealing element comprises a material having a tensile strength within a range of about 200 MPa to about 550 MPa.

25. A seal, according to claim 1, wherein the sealing element comprises a material having a hardness within a range of about 60 Rb to about 90 Rb.

26. A seal, according to claim 1, wherein the sealing element comprises a brush plated layer disposed on the end portion.

27. A seal, according to claim 1, wherein the sealing element comprises at least one metallic bead disposed on the end portion that has been machined to form a sealing profile.

28. A seal, according to claim 1, wherein the body comprises a structure cast around the sealing element.

29. A method of producing a seal, comprising:
providing a body comprising a deflectable intermediate portion terminating in an end portion; and
disposing a sealing element comprising a softer material than that of the body along the end portion of the body.

30. A method, according to claim 29, further comprising machining the sealing element to produce a sealing profile;

31. A method, according to claim 30, wherein machining the sealing element is performed before disposing the sealing element at the end portion.

32. A method, according to claim 30, wherein machining the sealing element is performed after disposing the sealing element at the end portion.

33. A method, according to claim 29, further comprising generating a groove in the end portion of the body and retaining the sealing element within the groove.

34. A method, according to claim 29, further comprising:
generating a recess in the body; and
securing a retainer to the end portion to capture the sealing element on the recess.

35. A method, according to claim 34, wherein securing the retainer further comprises securing the retaining via a wire ring disposed in aligned grooves defined by the end portion and the retainer.

36. A method, according to claim 34, wherein securing the retainer further comprises securing the retainer with a fastener.

37. A method, according to claim 29, wherein disposing the sealing element further comprises securing the sealing element to the end portion by a method selected from the group consisting of gluing, welding, soldering, and edge punching.

38. A method, according to claim 29, wherein disposing the sealing element further comprises press fitting the sealing element onto the end portion.

39. A method, according to claim 29, further comprises generating an undercut in the end portion, wherein disposing the sealing element further comprises upsetting a portion of the sealing element into the undercut.

40. A method, according to claim 29, wherein disposing the sealing element further comprises riveting the sealing element to the body.

41. A method, according to claim 29, wherein disposing the sealing element further comprises brush plating a layer onto a sealing subprofile.

42. A method, according to claim 29, wherein disposing the sealing element further comprises applying at least one bead of sealing element material onto the end portion.

43. A method, according to claim 29, wherein disposing the sealing element further comprises casting the body around the sealing element.

44. A seal, comprising:
a body comprising a deflectable intermediate portion terminating in an end portion;
a sealing element comprising a softer material than that of the body and disposed along the end portion of the body; and
means for retaining the sealing element at the end portion.

45. A seal, according to claim 44, wherein the means for retaining the sealing element comprises a groove defined by the body in which the sealing element is retained.

46. A seal, according to claim 44, wherein the means for retaining the sealing element comprises a retainer secured to the body;

47. A seal, according to claim 44, wherein the means for retaining the sealing element comprises one of an edge punch, a weld, glue, solder, and a rivet.

48. A seal, according to claim 44, wherein the means for retaining the sealing element comprises an undercut defined by the body and a portion of the sealing element upset into the undercut.

49. A seal, according to claim 44, the means for retaining the sealing element comprises a bond between the sealing element and the body.
